(19) United States
(12) Patent Application Publication
(10) Pub. No.: US 2007/0154702 A1
(43) Pub. Date: Jul. 5, 2007

(54) Glassy carbon coated carbon foam

(76) Inventors: Douglas J. Miller, North Olmstead, OH (US); Irwin C. Lewis, Strongsville, OH (US); Richard L. Shao, North Royalton, OH (US)

Correspondence Address: Waddey & Patterson P.C.;Suite 500, Roundabout Plaza, 1600 Division Street, Nashville, TN, 37203, US

(21) Appl. No.: 11/321,693

(22) Filed: Dec. 29, 2005

(51) Int. Cl. B32B 9/00

(52) U.S. Cl. 428/318.4; 428/319.1; 428/318.6; 428/319.3

(57) ABSTRACT

A glassy carbon coated carbon foam material is formed by coating carbon foam with a glassy carbon layer. Carbon foam may be produced by carbonizing a phenolic or polyurethane foam at high temperatures in an inert atmosphere. The carbon foam is then machined to a desired shape and treated with a fine carbon or graphite powder to the surface. Subsequently a resin is applied to the surface of the carbon foam, and the coated carbon foam block is fired to carbonize the resin coating into a glassy carbon coating. The firing and coating are repeated until the desired coating thickness and surface properties are achieved.

### BACKGROUND OF THE INVENTION

1. Technical Field

The present invention relates to glassy carbon coated carbon foams useful for high temperature and/or high strength applications, such as in metallurgical processes where resistance to wetting and to infiltration by molten metals is desirable. More particularly, the present invention enables large, lightweight insulating materials to be produced that have resistance to chemical attacks and also the temperature resistance of ceramic coated graphite while exhibiting superior strength, weight and density characteristics. The invention also includes methods for the production of such foams.

2. Background Art

Carbon foams have attracted considerable recent activity because of their properties of low density, coupled with either very high or low thermal conductivity. Conventionally, carbon foams are prepared via two general routes. Highly graphitizable foams have been produced by thermal treatment of mesophase pitches under high pressure. These foams tend to have high thermal and electrical conductivities. For example, in Klett, U.S. Pat. No. 6,033,506, mesophase pitch is heated while subjected to a pressure of 1000 psi to produce an open-cell foam containing interconnected cells with a size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cm³).

In Hardcastle et al. (U.S. Pat. No. 6,776,936), carbon foams with densities ranging from 0.68-1.5 g/cm³ are produced by heating pitch in a mold at pressures up to 800 psi. The foam is alleged to be highly graphitizable and provide high thermal conductivity (250 W/m° K).

According to H. J. Anderson et al. in Proceedings of the 43rd International SAMPE Meeting, p. 756 (1998), carbon foam is produced from mesophase pitch followed by oxidative thermosetting and carbonization to 900° C. The foam has an open-cell structure of interconnected cells with varying shapes and with cell sizes ranging from 39 to greater than 480 microns.

Rogers et al., in Proceedings of the 45^{th} SAMPE Conference, p. 293 (2000), describe the preparation of carbon foams from coal-based precursors by heat treatment under high pressure to produce foam materials with densities of 0.35-0.45 g/cm³ and compressive strengths of 2000-3000 psi (thus a strength/density ratio of about 6000 psi/(g/cm³)). These foams have an open-cell structure of interconnected pores with cell sizes up to 1000 microns. Unlike the mesophase pitch foams described above, the coal-based carbon foams are not highly graphitizable. In a recent publication, the properties of this type of foam were described (High Performance Composites, September 2004, p. 25). The foam has a compressive strength of 800 psi at a density of 0.27 g/cm³ or a strength-to-density ratio of 3000 psi/(g/cm³).

Stiller et al. (U.S. Pat. No. 5,888,469) describe production of carbon foam by pressure heat treatment of a hydrotreated coal extract. These materials are claimed to have high compressive strengths of 600 psi for densities of 0.2-0.4 g/cm³ (strength/density ratio of from 1500-3000 psi/(g/cm³)). It is suggested that these foams are stronger than those having a glassy carbon or vitreous nature that are not graphitizable.

Carbon foams can also be produced by direct carbonization of polymers or polymer precursor blends. Mitchell, in U.S. Pat. No. 3,302,999, discusses preparing carbon foams by heating a polyurethane foam at 200-255° C. in air followed by carbonization in an inert atmosphere at 900° C. These foams have densities of 0.085-0.387 g/cm³ and compressive strengths of 130 to 2040 psi (ratio of strength/density of 1529-5271 psi/(g/cm³)).

In U.S. Pat. No. 5,945,084, Droege describes the preparation of open-cell carbon foams by heat treating organic gels derived from hydroxylated benzenes and aldehydes (phenolic resin precursors). The foams have densities of 0.3-0.9 g/cm³ and are composed of small mesopores with a size range of 2 to 50 nm.

Mercuri et al. (Proceedings of the 9^{th} Carbon Conference, p. 206 (1969)) prepare carbon foams by pyrolysis of phenolic resins. For foams with a density range of 0.1-0.4 g/cm³, the compressive strength-to-density ratios are at 2380-6611 psi/(g/cm³). The pores were ellipsoidal in shape with pore diameters of 25-75 microns) for a carbon foam with a density of 0.25 g/cm³.

Stankiewicz (U.S. Pat. No. 6,103,149) prepares carbon foams with a controlled aspect ratio range of 0.6-1.2. The patentee points out that users often require a completely isotropic foam for superior properties with an aspect ratio of 1.0 being ideal. An open-cell carbon foam is produced by impregnation of a polyurethane foam with a carbonizable resin followed by thermal curing and carbonization. The cell aspect ratio of the original polyurethane foam is thus changed from 1.3-1.4 to 0.6-1.2.

Glassy carbon products are used in a variety of applications due to their unique chemical and thermal properties. Their chemical resistance characteristics are desirable in chemical laboratory applications where vessels resistant to acids, bases and oxidants are needed. Additionally, glassy carbon products are used in metallurgical processes where the glassy carbon's high thermal stability precludes reaction with molten metals. Glassy carbon coatings have been applied to bulk graphite products to provide an impervious surface and to prevent carbon contamination during high temperature processing of metals. Generally, the most economical and convenient method of producing a glassy carbon coating is to apply a thermosetting resin to a substrate so that the resin produces a glassy carbon coating after carbonization. For optimal results, the substrate must possess a similar coefficient of thermal expansion (CTE) to the glassy carbon coating throughout the temperature range of thermal cycles while also possessing a fine surface porosity so that a continuous coating can be achieved. Graphite is a common substrate; however, difficulty exists in matching the coefficient of thermal expansion (CTE) of a particular graphite to the glassy carbon coating. Furthermore, graphite is a polycrystalline material and exhibits a very different temperature dependence for dimensional change when compared to non-crystalline glassy carbon. Thus, graphite is suitable as a substrate for glassy carbon where the temperature change is minimal but not for commercial applications requiring thermal cycling over a wide temperature range.

What is desired, therefore, is an impervious glassy carbon coated carbon foam that is a monolithic, lightweight, and low thermal mass product where the glassy carbon coating provides a protective surface in high temperature metal processing and is capable of surviving many thermal cycles over a wide temperature range. Indeed, a combination of characteristics, including the use of glassy carbon foam as a substrate material, an improved similarity of CTEs, controllable substrate density and strength to density ratios higher than those contemplated in the prior art, have been found to be an improvement over the prior art and necessary for use in high temperature thermal cycling applications. Also desired is a process for preparing such foams.

### SUMMARY OF THE INVENTION

The present invention provides a carbon foam that exhibits low density, high compressive strength and high compressive strength to density ratio to provide a combination of strength, durability, and relatively lightweight characteristics not heretofore seen. In addition, the monolithic nature and bimodal cell structure of the foam, with a combination of larger and smaller cells, which are relatively spherical, provide a carbon foam which can be produced in a desired size and configuration and which can be readily machined.

More particularly, the inventive carbon foam has a density of about 1 to about 40 pounds per cubic foot (lb/ft³), with a compressive strength of at least about 2000 pounds per square inch (psi) (measured by, for instance, the ASTM C695 method). An important characteristic for the foam when intended for use in a high temperature application is the ratio of strength to density. For such applications, a ratio of compressive strength to density of at least about 7000 psi/(g/cm³) is required, more preferably at least about 8000 psi/(g/cm³).

The inventive carbon foam should have a relatively uniform distribution of cells in order to provide the required high compressive strength. In addition, the cells should be relatively isotropic, by which is meant that the cells are relatively spherical, meaning that the cells have, on average, an aspect ratio of between about 1.0 (which represents a perfect spherical geometry) and about 1.5. The aspect ratio is determined by dividing the longer dimension of any pore with its shorter dimension.

The foam should have a total porosity of about 50% to about 95%, more preferably about 60% to about 95%. In addition, it has been found highly advantageous to have a bimodal cell distribution, that is, a combination of two average cell sizes, with the primary fraction being the larger size cells and a minor fraction of smaller size cells. Preferably, of the cells, at least about 90% of the cell volume, more preferably at least about 95% of the cell volume should be the larger size fraction, and at least about 1% of the cell volume, more preferably from about 2% to about 10% of the cell volume, should be the smaller size fraction.

Carbon foam for use as a substrate for large glassy carbon coated products has a desired cell size ranging from about 10 to about 200 microns, depending on the density of the foam product. This range of cell sizes allows for the bonding of the glassy carbon coating to the surface of the carbon foam substrate. The larger cell fraction of the bimodal cell distribution in the inventive carbon foam should preferably be about 10 to about 150 microns in diameter, more preferably about 15 to about 95 microns in diameter, most preferably about 25 to about 95 microns in diameter. The smaller fraction of cells should comprise cells that have a diameter of about 0.8 to about 3.5 microns, more preferably about 1 to about 2 microns. The bimodal cell structure nature of the inventive foams provides an intermediate structure between open-celled foams and closed-cell foams, thus limiting the fluid permeability of the foam while maintaining a foam structure. Indeed, advantageously, the inventive carbon foams should exhibit a nitrogen gas permeability of no greater than about 3.0 darcys, more preferably no greater than about 2.0 darcys (as measured, for instance, by the ASTM C577 method).

Advantageously, to produce the inventive foams, a polymeric foam block, particularly a phenolic foam block, is carbonized in an inert or air-excluded atmosphere, at temperatures which can range from about 500° C., more preferably at least about 800° C., up to about 3200° C. to prepare carbon foams useful in high temperature applications.

An object of the invention is to provide a glassy carbon coated carbon foam having improved thermal and durability characteristics which enable it to be employed for commercial applications where a wide temperature range is necessary for thermal cycling and where carbon contamination can be minimized.

Another object of the invention, therefore, is a monolithic carbon foam having characteristics that enable it to be employed in high temperature applications such as high temperature furnace construction, core materials for sandwich structures, and composite tooling.

Yet another object of the invention is a carbon foam having improved durability, density, compressive strength and ratio of compressive strength to density sufficient for high temperature applications.

Still another object of the invention is a carbon foam having a porosity and cell structure and size distribution to provide utility in applications where highly connected porosity is undesirable.

Yet another object of the invention is a carbon foam which can be produced in a desired block size and configuration, and which can be readily machined or joined to provide larger carbon foam structures.

Another object of the invention is to provide a method of producing the inventive carbon foam.

These aspects and others that will become apparent to the artisan upon review of the following description can be accomplished by providing a carbon foam article produced using a resin-based foam, such as a phenolic resol, formed by polymerization and then carbonized to produced a carbon foam. This carbon foam possesses unique surface properties thus lends itself to stable coatings by providing compliance at the coating interface. The cell size of the foam is fine enough to be coated with a uniform continuous layer by conventional application techniques such as dipping, brushing or spraying. Moreover, the glassy carbon coated carbon foam has an improved durability in thermal cycling applications because of the compatibility of the CTE between the glassy carbon coating and the carbon foam substrate. Additionally, the glassy carbon coating minimizes any degradation through either impregnation or abrasion.

The inventive carbon foam has a ratio of compressive strength to density of at least about 7000 psi/(g/cm³), especially a ratio of compressive strength to density of at least about 8000 psi/(g/cm³). The inventive foam product advantageously has a density of from about 0.03 to about 0.6 and a compressive strength of at least about 2000 psi, and a porosity of between about 50% and about 95%. The cells of the carbon foam have, on average, an aspect ratio of between about 1.0 and about 1.5.

Preferably, at least about 90% of the cell volume is made of the cells having a diameter of between about 10 and about 150 microns; indeed, most preferably at least about 95% of the cell volume is made of the cells having a diameter of between about 25 and about 95 microns. Advantageously, at least about 1% of the cell volume is made of the cells having a diameter of between about 0.8 and about 3.5 microns, more preferably, from about 2% to about 10% of the cell volume is made of the cells having a diameter of about 1 to about 2 microns.

The inventive foam can be produced by carbonizing a polymeric foam article, especially a phenolic foam, in an inert or air-excluded atmosphere. The phenolic foam should preferably have a compressive strength of at least about 100 psi.

It is to be understood that both the foregoing general description and the following detailed description provide embodiments of the invention and are intended to provide an overview or framework of understanding to nature and character of the invention as it is claimed.

### DETAILED DESCRIPTION OF THE PREFERRED EMBODIMENTS

Carbon foams in accordance with the present invention are prepared from polymeric foams, such as polyurethane foams or phenolic foams, with phenolic foams being preferred. Phenolic resins are a large family of polymers and oligomers, composed of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system composed of open and closed cells. The resins are generally aqueous resoles catalyzed by sodium hydroxide at a formaldehyde-to-phenol ratio which can vary, but is preferably about 2:1. Free phenol and formaldehyde contents should be low, although urea may be used as a formaldehyde scavenger.

The foam is prepared by adjusting the water content of the resin and by adding a surfactant (e.g., an ethoxylated nonionic), a blowing agent (e.g., pentane, methylene chloride, or chlorofluorocarbon), and a catalyst (e.g., toluenesulfonic acid or phenolsulfonic acid). The sulfonic acid catalyzes the reaction, while the exotherm causes the blowing agent, emulsified in the resin, to evaporate and hence expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred phenol is resorcinol; however, other phenols of similar kind that are able to form condensation products with aldehydes can also be used. Such phenols include monohydric and polyhydric phenols, pyrocatechol, hydroquinone, alkyl substituted phenols, such as, for example, cresols or xylenols, polynuclear monohydric or polyhydric phenols, such as, for example, naphthols, p.p′-dihydroxydiphenyl dimethyl methane or hydroxyanthracenes.

The phenols used to make the foam precursor material can also be used in admixture with non-phenolic compounds that are able to react with aldehydes in the same way as phenol.

The preferred aldehyde for use in the solution is formaldehyde. Other suitable aldehydes include those that will react with phenols in the same manner. These include, for example, acetaldehyde and benzaldehyde.

In general, the phenols and aldehydes that can be used in the process of the invention are those described in U.S. Pat. Nos. 3,960,761 and 5,047,225, the disclosures of which are incorporated herein by reference.

In order to create a glassy carbon coating on carbon foam, the carbon foam should be a non-graphitizing glassy carbon foam and thus prepared to have an outer surface compatible for receiving a coating. The preferred method for creating glassy carbon foam is by carbonizing a phenolic or polyurethane foam in an inert atmosphere at a temperature of about 500° C. to about 3100° C. The resulting glassy carbon foam block will have a cell size ranging from about 10 microns to about 200 microns providing an optimally smooth surface for coatings to be applied. Furthermore, this carbon foam can either be machined to a specific shape or bonded to other carbon foam blocks to form the desired final shape.

A fine powder-filled paste coating of either carbon or graphite particulate is then applied to the surface of the carbon foam to limit the depth of penetration of the subsequent coating into the carbon foam's cells. The powder's particulates are of two distinct sizes, with the larger particulates having an average size at least two times that of the smaller particulates. The larger particulates should preferably be about 2 to about 500 microns in diameter, more preferably about 2 to about 300 microns in diameter, most preferably about 2 to about 120 microns in diameter. The smaller particulates should preferably have an average size of about 0.2 microns to about 10 microns in diameter, more preferably about 0.5 to about 5 microns in diameter, most preferably about 0.5 microns to about 2 microns in diameter.

Next, a high char yield resin is applied to the surface of the carbon foam, that is prepared with a fine powder-filled paste, as either a resin solution or resin slurry. The preferred resin is a phenolic, furan, vinylidene chloride, or similar polymer that will not form graphitic carbon when subjected to high temperatures. The coated carbon foam is then heat treated to from about 500° C. to about 800° C., preferably from about 600° C. to about 800° C. to carbonize the high char yield coating to form a glassy carbon coating. Several coating and heat-treating steps may be required to produce the desired coating thickness and surface properties of the glassy carbon coating.

Ideally, the density of the carbon foam will be selected to comply with the specific CTE of the glassy carbon coating. As the coating's strength and thickness are reduced, the density of the carbon foam substrate is also reduced so that the ligaments of the foam fracture during thermal cycles instead of the glassy carbon coating. This is the preferable method of accommodating stresses generated during thermal cycling as the fracture of a few cell ligments of the carbon foam is less problematic than failure of the glassy carbon coating.

The polymeric foam precursor prepared as described above, which is used as the starting material in the production of the inventive carbon foam, should have an initial density that mirrors the desired final density for the carbon foam to be formed. In other words, the polymeric foam should have a density of about 0.1 to about 0.8 g/cm³, more preferably about 0.1 to about 0.6 g/cm³. The cell structure of the polymeric foam should be closed with a porosity of between about 50% and about 95% and a relatively high compressive strength, i.e., on the order of at least about 100 psi, and as high as about 300 psi or higher.

In order to convert the polymeric foam to carbon foam, the foam is carbonized by heating to a temperature of from about 500° C., more preferably at least about 800° C., up to about 3200° C., in an inert or air-excluded atmosphere, such as in the presence of nitrogen. The heating rate should be controlled such that the polymeric foam is brought to the desired temperature over a period of several days, since the polymeric foam can shrink by as much as about 50% or more during carbonization. Care should be taken to ensure uniform heating of the polymeric foam article for effective carbonization.

By use of a polymeric foam heated in an inert or air-excluded environment, a non-graphitizable carbon foam is obtained, which has the approximate density of the starting polymeric foam, but a compressive strength of at least about 2000 psi and, significantly, a ratio of strength to density of at least about 7000 psi/(g/cm³), more preferably at least about 8000 psi/(g/cm³). The carbon foam has a relatively uniform distribution of isotropic cells having, on average, an aspect ratio of between about 1.0 and about 1.5.

The resulting carbon foam has a total porosity of about 50% to about 95%, more preferably about 60% to about 95% with a bimodal cell distribution; at least about 90%, more preferably at least about 95%, of the cell volume is made of the cells of about 10 to about 150 microns in diameter, more preferably about 15 to about 95 microns in diameter, most preferably about 25 to about 95 microns in diameter, while at least about 1%, more preferably about 2% to about 10%, of the cell volume is made of the cells of about 0.8 to about 3.5 microns, more preferably about 1 to about 2 microns, in diameter. The bimodal cell size distribution nature of the inventive foam provides an intermediate structure between open-cell foams and closed-cell foams, limiting the fluid permeability of the foam while maintaining a foam structure. Nitrogen gas permeabilities less than 3.0 darcys, even less than 2.0 darcys, are preferred.

Typically, characteristics such as porosity and individual cell size and shape are measured optically, such as by use of an optical microscopy using bright field illumination, and are determined using commercially available software, such as Image-Pro Software available from MediaCybernetic of Silver Springs, Md.

The cell structure of the foam is unique as compared, to other foams in that it is intermediate to a closed-cell and open-cell configuration. The large cells appear to be only weakly connected to each other and connected by the fine porosity so that the foam exhibits permeability in the presence of water but does not readily absorb more viscous liquids.

Accordingly, by the practice of the present invention, carbon foams having heretofore unrecognized characteristics are prepared. These foams exhibit exceptional oxidation resistance as well as high compressive strength to density ratios and have a distinctive bimodal cell structure, making them uniquely effective at applications, such as composite tooling applications.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for creating a glassy carbon coated carbon foam, which comprises the steps of:
a) carbonizing a foam product to form a carbon foam material having a surface;
b) applying a filler to the surface of the carbon foam material to create a surface-filled carbon foam material;
c) coating the surface-filled carbon foam material with a high char yield resin coating to create a coated carbon foam material; and
d) heating the coated carbon foam material to carbonize the high char yield resin coating to create a glassy carbon coated carbon foam material.

2. The method of claim 1 wherein in step a) the foam product is selected from the group consisting of phenolic foam and polyurethane foam.

3. The method of claim 1 wherein step a) further comprises carbonizing the foam product in an inert atmosphere.

4. The method of claim 1 wherein step a) further comprises heating the foam product at a temperature of from about 500 degrees Celsius to about 3100 degrees Celsius.

5. The method of claim 1 wherein the filler of step b) comprises a powder of from about 0.2 microns in diameter to about 500 microns in diameter and a liquid binder; the powder selected from the group consisting of carbon, carbon black, coke, graphite powder and combinations thereof.

6. The method of claim 1 wherein in step c) the high char yield resin coating is selected from the group consisting of phenolic resins, furans, vinylidene chlorides and non-graphitizing polymers.

7. The method of claim 1 wherein in step c) the high char yield resin coating is applied as a solution.

8. The method of claim 1 wherein in step c) the high char yield resin coating is applied as a slurry.

9. The method of claim 1 further comprising repeating step c) and step d) to increase the thickness of the glassy carbon coating.

10. The method of claim 9 wherein the glassy carbon coating thickness is from about 25 microns to about 500 microns.

11. A method for creating a glassy carbon coated carbon foam, comprising:
a) carbonizing a foam in an inert atmosphere to form a carbon foam substrate;
b) machining the carbon foam substrate to a carbon foam with a desired shape;
c) powder-filled coating the carbon foam of step b) with a filler to create a surface-filled carbon foam;
d) coating the surface-filled carbon foam with a resin to create a resin coated carbon foam;
e) carbonizing the resin coating of the resin coated carbon foam to create a glassy carbon coated carbon foam; and
f) repeating steps d) and e) to create a final glassy carbon coated carbon foam with a glassy carbon coating thickness in the range of from about 25 microns to about 500 microns.

12. A coated carbon foam comprising a coating layered on the surface of a carbon foam.

13. The foam of claim 12 wherein the coating is a ceramic coating.

14. The foam of claim 12 wherein the coating is a glassy carbon coating.

15. The foam of claim 14 wherein the glassy carbon coating has a thickness of from about 25 microns to about 500 microns.

16. The foam of claim 14 wherein the glassy carbon coating is a carbonized resin.

17. The foam of claim 16 wherein the carbonized resin is selected from the group consisting of phenolic resins, furans, vinylidene chlorides and non-graphitizable polymers.

18. The foam of claim 14 wherein the glassy carbon coating has a higher specific strength than the carbon foam.

19. The foam of claim 14 wherein the glassy carbon coating has a coefficient of thermal expansion of from about 2×10⁻⁶/° C. to about 6×10⁻⁶/° C.

20. The foam of claim 19 wherein the carbon foam has a coefficient of thermal expansion within of from about 40% to about 85% of the coefficient of thermal expansion of the glassy carbon coating.

21. The foam of claim 12 wherein the carbon foam has a cell size ranging from about 10 to about 200 microns.

22. The foam of claim 12 wherein the carbon foam is a monolithic carbon foam, the monolithic carbon foam having a length of about 200 cm.

23. The foam of claim 12 wherein the carbon foam has a density of from about 1 to about 40 pounds per cubic foot.

24. The foam of claim 12 wherein the carbon foam is comprised of a plurality of carbon foam blocks bonded together.

25. The foam of claim 24 wherein the coating is layered on the surface of the plurality of carbon foam blocks bonded together.
